(19) United States
(12) Patent Application Publication
(10) Pub. No.: US 2005/0093204 A1
(43) Pub. Date: May 5, 2005

(54) Stamping apparatus

(76) Inventor: David W. Gregg, Shawnee, KS (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/981,192

(22) Filed: Nov. 4, 2004

Related U.S. Application Data
(60) Provisional application No. 60/517,528, filed on Nov. 5, 2003.
(60) Provisional application No. 60/518,723, filed on Nov. 10, 2003.

(51) Int. Cl. B29C 59/04

(52) U.S. Cl. 264/284; 425/369; 425/374; 249/140

(57) ABSTRACT

A rolling stamping apparatus that can be manipulated by hand is for imprinting patterns, textures, or both into various materials, typically those that cure or harden, such as concrete, plaster stucco, clay tile. The apparatus is lightweight, and compact, such that it can be used for stamping borders and edges in concrete, plaster, stucco, material overlays and the like.

### CROSS-REFERENCES TO RELATED APPLICATIONS

This application is related to and claims priority from U.S. Provisional Patent Application Ser. No. 60/517,528 filed on Nov. 5, 2003 and U.S. Provisional Patent Application Ser. No. 60/518,723, filed on Nov. 10, 2003, both applications entitled: STAMPING APPARATUS. Both of these U.S. Provisional Patent Applications are incorporated by reference herein.

### TECHNICAL FIELD

The present invention is directed to apparatus and methods for stamping concrete. In particular, the apparatus is a hand manipulated apparatus for stamping concrete borders and edges.

### BACKGROUND OF THE INVENTION

Concrete is a staple in the construction industry. It is a preferred material because of its costs. Concrete is typically poured in slabs. Typically, the poured concrete slabs are given a broom finish pattern, by merely sweeping over the concrete with a broom or the like and letting it harden and dry.

Other finish patterns can be put into concrete, to create other aesthetically pleasing surfaces. These finish patterns are typically stamped into the concrete by placing flat mats with patterns over the concrete, “tamping” the mats, with rods and the like, into contact with the wet concrete, and removing these flat mats.

Finish patterns can also be placed into concrete by the roller apparatus and methods for their use disclosed in commonly owned U.S. Patent Applications: Ser. No. 10/603,340, Ser. No. 10/697,364, and Ser. No. 10/932,822, all three of these patent applications are incorporated by reference herein.

The rolling apparatus disclosed in these patent applications improve on the flat mats and “tamping” systems of the contemporary art, by reducing the numbers of workers required to operate the apparatus and work the concrete, as well as allow for adjusting the weight on the roller based on the tightness of the concrete, including various portions of the tightening concrete.

The finished concrete is typically in slabs, with each slab typically having a pattern, or a pattern and a texture, imprinted therein, with edges bordering the imprinted area. These edges can be provided with a border where desired. Additionally, in the case of smooth finished concrete, it may be desired to place smaller patterns, or patterns and textures into the concrete, as well as create borders at the ends of the stamped areas. It may even be desired to place patterns, or patterns and textures, into the larger patterns.

These further finishes, to create borders or additional patterns, or patterns and textures, are typically performed by using the same apparatus. This apparatus may be bulky or unwieldy for borders and edges. Alternately, the imprints have been placed into the borders and edges by using smaller “tamping” mats, similar to the larger mats or hand working the desired imprints into the concrete. The use of smaller mats and hand working typically results in non-uniformities in the stamped concrete. Additionally, hand crafting is labor intensive, it requires a skilled worker, and accordingly, is expensive.

### SUMMARY OF THE INVENTION

The present invention improves on the contemporary art by providing a rolling stamping apparatus for imprinting patterns, textures, or both into various materials, typically those that cure or harden, such as concrete, plaster stucco, clay tile. It is lightweight, and compact, such that it is useful for stamping (imprinting) borders and edges in concrete, plaster, stucco, material overlays and the like (with patterns, textures or both). The apparatus is also such that it is a hand-held apparatus that can be hand manipulated, in order to stamp borders and edges that typically require significant detail. The apparatus and methods for its use will provide for a uniformly stamped border, edge or the like. Moreover, by providing a stamp that allows for uniform imprinting, highly skilled labor is not needed, whereby costs associated with stamping are reduced.

An embodiment of the invention is directed to an apparatus for imprinting in materials, such as concrete and the like. The apparatus has a roller including a surface defined by a stamp; and a handle. The handle is configured to be held and manipulated by a hand. The handle also has a portion for defining an axle for the roller, with the roller received on the axle in a rotatable engagement.

Another embodiment of the invention is directed to an apparatus for imprinting in materials. The apparatus has a roller and a handle. The roller has a surface and a bore extending therethrough. The handle is configured to be held and manipulated by a hand, and has a portion for defining an axle for receiving the roller. The axle is of a diameter to fit within the bore to frictionally retain the roller on the axle in a rotatable engagement.

Another embodiment of the invention is directed to method for imprinting in materials, such as concrete. The method includes providing an apparatus for imprinting in materials, the apparatus having a roller including a surface defined by a stamp and a handle. The handle is configured to be held and manipulated by a hand, and includes a portion for defining an axle for the roller, with the roller received on the axle in a rotatable engagement. The apparatus is moved by hand manipulation over a portion of the material while it is in at least an uncured state, to transfer the imprint from the stamp of the roller to the surface of the material.

### BRIEF DESCRIPTION OF THE DRAWINGS

Attention is now directed to the drawing figures, where corresponding or like numerals indicate corresponding or like components. In the drawings:

FIG. 1 is a perspective view of an apparatus in accordance with an embodiment of the invention;

FIG. 2 is a view of the embodiment of FIG. 1 with the rollers removed from the handle;

FIG. 3 is a perspective view of an apparatus accordance with the invention with another roller;

FIG. 4 are perspective views of other rollers suitable for use with the handle member; and

FIG. 5 shows the apparatus of FIG. 1 in an exemplary operation.

### DETAILED DESCRIPTION OF THE DRAWINGS

The present invention is directed to a stamping apparatus for imprinting patterns, textures, or both into various materials, typically those that cure or harden, such as concrete, plaster stucco, clay tile, or the like. It can also be used for borders and edges in concrete, plaster, stucco, material overlays and the like. The imprints are typically made in the material while it is uncured, tightening, curing, wet, soft, malleable, or in another intermediate or non-permanent state.

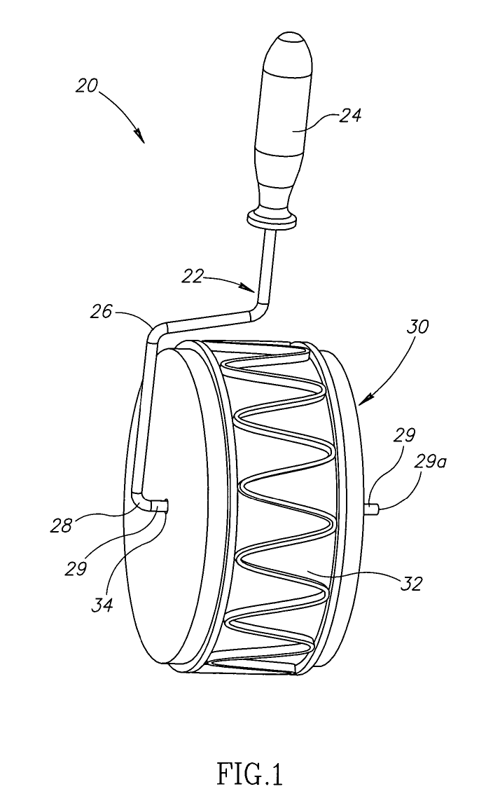

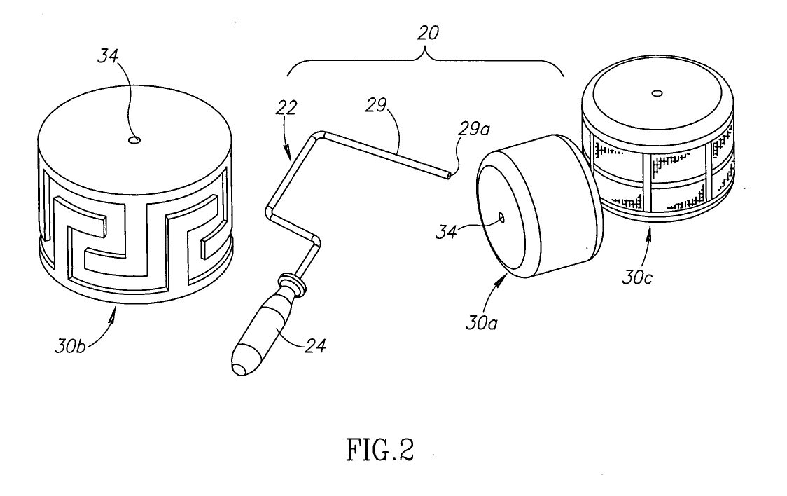

Turning to FIGS. 1 and 2, the apparatus 20 of the present invention, typically includes a handle 22 formed of a gripping portion 24 and a bent portion 26. The end 28 of the bent portion 26, opposite the gripping portion 24, forms an axle 29 for the head 30. The head 30 is a roller or the like, cylindrical in shape, whose outer surface 32 includes a stamp, typically formed of a pattern, texture (relief to various depths), or both. It is this stamp that is imprinted into the material being worked. The head 30 is typically made of, for example, rubber, such as urethane, plastic, other polymeric materials, or combinations thereof.

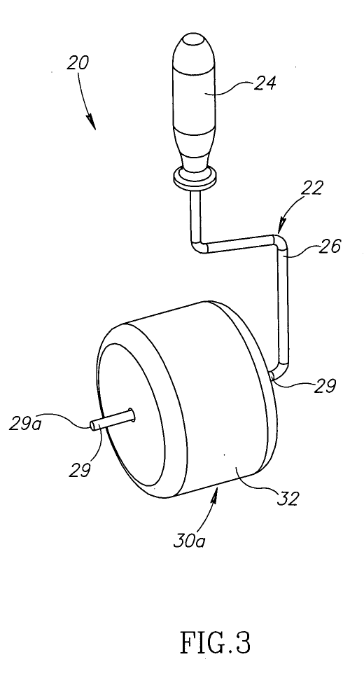

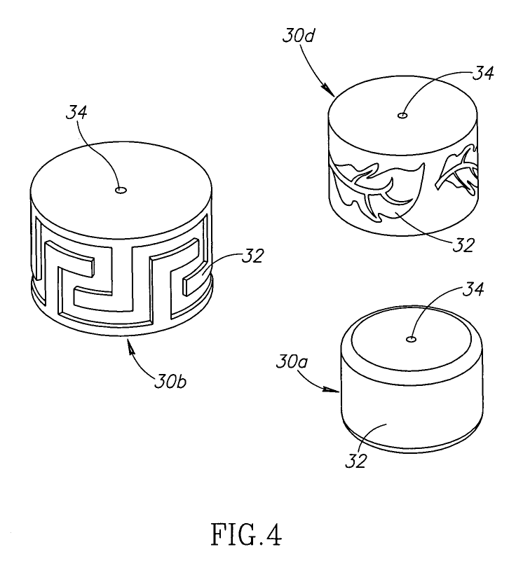

The head 30 is typically designed to be frictionally retained on the axle 29. The frictional retention is such that the head 30 is rotatable on the axle 29, yet remains in the same position on the handle 22. This is achieved as the head 30 includes a bore 34, extending therethrough, of a tolerance (diameter) to accommodate the axle 29. The tolerance of the bore 34, coupled with the material for the head 30, for example, urethane rubber or the like, allows for the head 30 to be in this frictional retention on the handle 22 at the axle 29, while remaining rotatable. This frictional retention is also such that heads 30 (and 30a-30d, 30d in FIG. 4) may be easily removed and replaced by a single user. For example, the head 30 may be replaced by the head 30a (FIG. 2) on the axle 29 of the handle 22, whereby the resultant apparatus 20 is shown in FIG. 3.

Alternately, the heads 30, 30a-30c may be maintained in position on the axle 29 by spacers (not shown), on one or both sides of head 30, and a stop member (not shown), at the end 29a of the axle 29. This stop member may be a washer, end cap, bolt, nut, or the like. If this arrangement is used, the bore 34 tolerances detailed above may be used, but can be more relaxed, so as to have a larger diameter.

As stated above, various heads 30 and 30a-30c can be used on a roller. These heads include rollers with smooth surfaces 30a (without a pattern or a texture), patterns 30b, textures and patterns 30c, 30d (FIG. 4). The heads 30a-30d may be made of materials such as those disclosed above for the head 30. These heads 30, 30a-30d are also such that they can be coated with release materials, such as water, oil, Mat-Crete™ and the like, allowing for a smooth release from concrete.

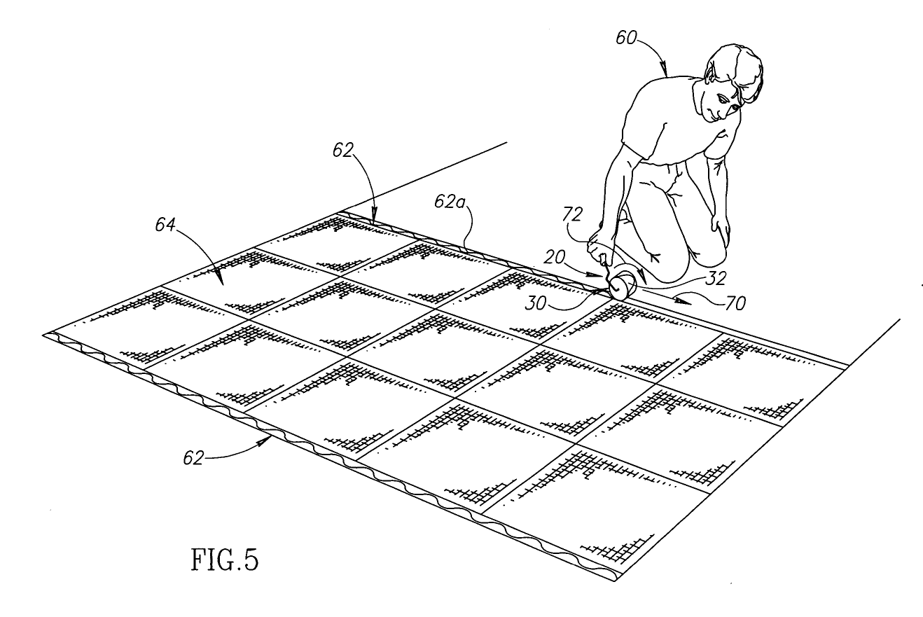

FIG. 5 shows the apparatus 20 in an exemplary operation. Here, the apparatus 20 is being operated by a user 60 to create a border 62 between a finished 64 and unfinished 66 slab of concrete. For example, the unfinished state in which the concrete is being worked is during the time it is tightening or curing. For example, this results in the finished slab 64 imprinted or stamped with a pattern and texture from one of the apparatus disclosed in U.S. patent applications Ser. No. 10/603,340, Ser. No. 10/697,364, and Ser. No. 10/932,822, leaving borders 62 at the ends of the slab 64.

The user moves the apparatus 20 forward, in the direction of the arrow 70. The user 60 applies pressure to the border strip 62a depending on the tightness of the concrete, allowing the head or roller 30 to rotate (in the direction of the arrow 72). Movement in this manner is such until the border strip 62a has been imprinted with the pattern, and or pattern and texture, of the roller 30.

While preferred embodiments of the present invention have been described, so as to enable one of skill in the art to practice the present invention, the preceding description is intended to be exemplary only. It should not be used to limit the scope of the invention, which should be determined by reference to the following claims.

1. An apparatus for imprinting in materials comprising:
a roller including a surface defined by a stamp; and
a handle configured to be held and manipulated by a hand, the handle including a portion for defining an axle for the roller, the roller received on the axle in a rotatable engagement.

2. The apparatus of claim 1, wherein the roller includes a bore extending therethrough, the bore of a tolerance with respect to the axle such that the rotastable engagement includes a frictional engagement.

3. The apparatus of claim 1, wherein the handle includes a gripping portion in communication with the axle portion.

4. The apparatus of claim 1, wherein the surface includes a pattern.

5. The apparatus of claim 4, wherein the surface includes a texture.

6. The apparatus of claim 1, wherein the surface includes a pattern and a texture.

7. A method for imprinting in a material comprising:
providing an apparatus for imprinting in materials comprising:
a roller including a surface defined by a stamp; and
a handle configured to be held and manipulated by a hand, the handle including a portion for defining an axle for the roller, the roller received on the axle in a rotatable engagement; and
moving the apparatus by hand manipulation over a portion of the material while it is in at least an uncured state, to transfer the imprint from the stamp of the roller to the surface of the material.

8. The method of claim 7, wherein the imprint includes a pattern.

9. The method of claim 8, wherein the imprint includes a texture.

10. The method of claim 7, wherein the imprint includes a pattern and a texture.

11. The method of claim 7, wherein the curable material includes concrete.

12. An apparatus for imprinting in materials comprising:
a roller including a surface and a bore extending therethrough; and
a handle configured to be held and manipulated by a hand, the handle including a portion for defining an axle for receiving the roller, the axle of a diameter to fit within the bore to frictionally retain the roller on the axle in a rotatable engagement.

13. The apparatus of claim 12, wherein the handle includes a gripping portion in communication with the axle portion.

14. The apparatus of claim 12, wherein the surface includes a pattern.

15. The apparatus of claim 14, wherein the surface includes a texture.

16. The apparatus of claim 12, wherein the surface includes a pattern and a texture.
